(19) United States
(12) Patent Application Publication
(10) Pub. No.: US 2004/0245055 A1
(43) Pub. Date: Dec. 9, 2004

(54) Mechanically and hydraulically actuated disc brake

(76) Inventors: Jean-Louis Gerard, Bagnolet (FR); Gerard Le Deit, Courtry (FR)

Correspondence Address: Leo H McCormick Jr, 2112 Mishawaka Avenue, PO Box 4721, South Bend, IN, 46634-4721, US

(21) Appl. No.: 10/488,733

(22) PCT Filed: Sep. 6, 2002
(86) PCT No.: PCT/FR02/03044

(30) Foreign Application Priority Data
Sep. 10, 2001 (FR) 0111757

(51) Int. Cl. F16D 55/02

(52) U.S. Cl. 188/72.6; 188/71.9

(57) ABSTRACT

This invention relates to a mechanically- and hydraulically actuated brake cylinder, in which the adjustment neutralization section is reduced, with the result that the cylinder may be more compact.

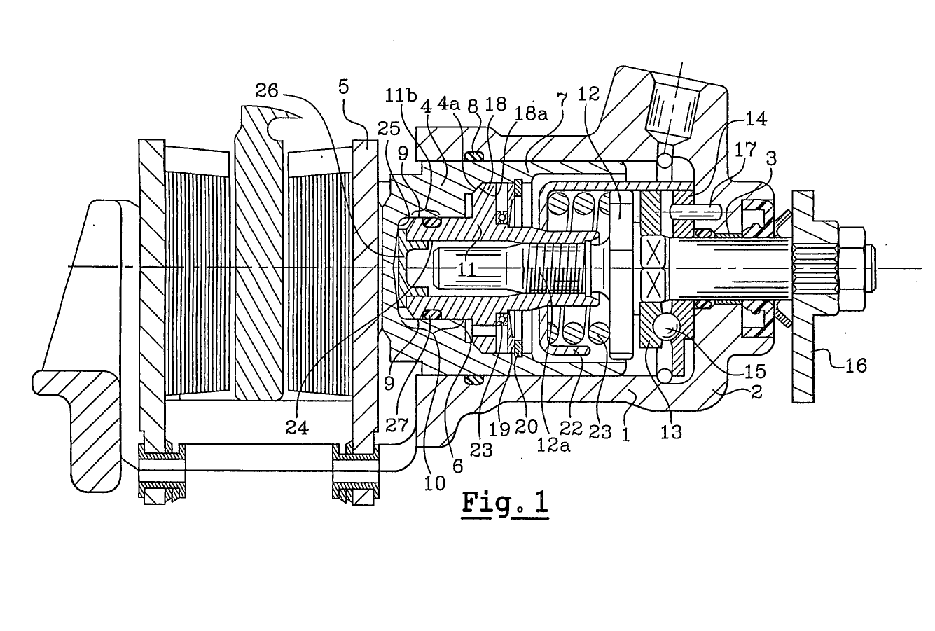

This invention relates to a mechanically- and hydraulically actuated brake cylinder for a motor vehicle, provided with an annular adjustment neutralization, and it also relates to a disc brake fitted with such a cylinder.

In a well-known manner, the mechanically- and hydraulically actuated brake cylinders consist of a piston capable of a translational motion under the action of a hydraulic fluid pressure or under the action of a combination of moving parts.

The hydraulic fluid is pressure-injected into the brake cylinder and it acts on the piston when the brake pedal is depressed, whereas the moving parts are brought into action when the vehicle driver actuates the parking brake.

In most vehicles, the actuation of the parking brake results in the tension of a cable, connected to a pivotally-mounted lever attached to the brake cylinder. A ramp-and-ball mechanism, also called a ball-in ramp (BIR), is provided inside the cylinder so as to convert the rotational motions of the lever into translational motions, to be applied to the piston.

Therefore, the brake cylinders, fitted with such ramp-and-ball mechanisms, comprise a shaft projecting from the cylinder and on which the cable-actuated lever is mounted. Said shaft is rigidly linked with a rotary plate, cooperating with a translationally-moving plate, with the intercalation of balls accommodated in ramps provided in both plates, in such a way that a rotational motion of the rotary plate results in a translational motion of the moving plate, which accordingly pushes a spacer, extending to the piston, so as to impart the translational motion from the moving plate to the piston.

Thus, the piston travels, through a translational motion the length of which is equal to the travel of the moving plate, from a rest position following a previous braking operation, and in which the pads are almost touching the disc but yet not pressing onto it, to a braking position, in which the pads are closely applied onto the disc.

Owing to the wear of the pads, the rest position of the piston is brought nearer to the disc, to a non-negligible extent relative to the translational motion. Therefore, the spacer must be made longer so as to match the distance between the piston at rest and the moving plate.

To this end, the use of an adjustable spacer is well known. Such a spacer consists of a screw and a nut, which are threaded the one into the other and capable of being unscrewed for the screw head to move away from the nut, thus lengthening the spacer.

In order to be adequate, such an adjustment must be automatically carried out inside the brake cylinder, as the friction linings wear out.

For the purpose, the screw is linked with the piston in its translational motions, whereas the spring prohibits the translational motions of the nut. Consequently, on the hydraulic control of the brake, the stroke of the piston drives the screw away from the nut, thus unscrewing it and lengthening the spacer.

This system is quite satisfactory but it must exhibit two further features, as follows.

The first essential condition lies in that the screw should not be capable of screwing up again into the nut, more particularly at the time of the mechanical actuation of the brake, i.e. when the spacer is compressed between the moving plate and the piston. That is the reason why, whereas the nut is permanently rotationally-locked, the screw is connected to the piston through a cone clutch having a slight axial play. When the cone clutch is resting, that is when the spacer is compressed against the piston by the moving plate, the piston secures the screw against any rotational motion. On the other hand, as soon as the cone clutch is no longer resting, thanks to its axial play, the screw can freely rotate about its axis.

Accordingly, the screw can unscrew at the time of the hydraulic braking operation so as to increase the length of the spacer, but it is not capable of screwing into the nut on a mechanical braking operation, in order that the spacer may keep its previously adjusted length.

As concerns the second feature, it is essential that the automatic adjustment of the spacer should not result in a jamming of the piston in the tight braking position, which might happen if the spacer actually lengthened by the full length of the piston stroke.

To this end, an end portion of the screw is slidably fitted inside the piston, with the interposition of a seal shielding said end portion of the screw, received inside the piston, from the hydraulic fluid pressure. Said portion has a cross section, which is called the neutralization section and thanks to which the pressure fluid imparts a resultant force to the screw so as to bias it close to the piston and thus cause the cone clutch to be resting, which means that the screw will not be capable of rotating any more and that the adjustment of the spacer will be inhibited. Such a resultant force opposes the force which is exerted by the spring, precluding a translational motion of the nut and, through a calibration of said spring, it is possible to set the limit pressure from which onwards the force, resulting from the hydraulic fluid pressure, can overcome the spring action and put an end to the adjusting process of the spacer. Then the spacer follows the travels of the piston, without any further lengthening.

In practice, the spring is calibrated to the highest possible value, considering that the limit resultant force is generally equal to 700 N, taking into account the dimension of the neutralization section and the fluid pressure at the time of the braking action.

Consequently, the nut-retaining spring must exhibit an adequate stiffness to resist a resultant force of 700 N.

As a matter of fact, the present inventors have found that the requisite strength of that spring is an obstacle to a volume reduction of the brake cylinder, because of the difficulty there is about the reduction of the dimensions of the various parts and, more particularly, of the spring.

Therefore, an object of this invention consists in resolving such difficulty, in that it provides a mechanically- and hydraulically actuated brake cylinder defining a tight chamber, capable of containing a pressure hydraulic fluid and housing a translationally-moving piston; a tappet-forming member which can be moved towards the piston on a mechanical actuation of the brake; a spacer interposed between the piston and the tappet-forming member and consisting of two elements, screwed the one into the other and capable of unscrewing so as to increase the length of the spacer, each element being in contact with a stop-forming part, i.e. the piston and the tappet-forming member respectively, the first one of the spacer-forming elements and the respective stop-forming part with which it cooperates being shaped in such a way that they can come into gear for a rotational motion when said element is bearing on said stop-forming part wherein the first spacer-forming element comprises an end portion engaging a bore provided in the stop-forming part, such bore being isolated from the chamber so that said end portion is not subjected to the fluid pressure of the chamber, with the result that the pressure fluid exerts, on said first element, an axial force in the direction of the corresponding stop-forming part, characterised in that a channel is provided through the first element, so as to connect the cylinder chamber with the bore in the stop-forming part, said channel being closed by a moving shutter which, under the action of the pressure fluid within the chamber, bears on the end wall of the bore while imparting substantially no axial force to said first spacer-forming element.

Thus, thanks to the invention, the action of the pressure hydraulic fluid on the first element is exerted only on the section of the end portion of said first element, minus the channel section which, owing to the moving shutter, is not under the hydraulic fluid pressure.

In other words, the neutralization section of the first element is the annular cross-section of the first element, situated about said channel.

It is plain that, since the neutralization section is reduced, the force applied by the fluid to the first element is reduced accordingly. Therefore the spring, which retains the second element and permits the adjustment of the spacer up to a limit pressure of the hydraulic fluid, must exhibit a reduced stiffness, proportional to the reduction of the neutralization section.

Thus, whereas the limit resultant force amounts to about 700 N, the limit resultant force of the cylinder according to the invention amounts to about 300 N only.

It results in that the retaining spring for the second element may be reduced appreciably, while serving the purpose quite well.

In a particular embodiment of the invention, the movable tappet-forming member is a ramp-and-ball mechanism comprising a swivelling input plate and a moving plate, between which balls are accommodated inside ramps provided in both plates.

According to a first embodiment of the present invention, the first spacer-forming element is a nut, the threaded hole of which constitutes the channel and wherein, preferably, the stop-forming part for the first element is the piston.

According to a second embodiment, the first spacer-forming element is a screw, the head of which is traversed by the channel, which opens laterally into the shank of said screw.

According to the invention, the moving shutter may be a sliding inserted piece comprising a cylindrical body received inside the channel which connects the cylinder chamber with the bore provided in the stop-forming part.

Other features and advantages of the present invention will be apparent from the following detailed description of an embodiment of this invention, by way of example and by no means as a limitation, when taken in conjunction with the accompanying drawing, in which the only figure is an axial sectional view of a brake cylinder according to an embodiment of this invention.

In the described embodiment, the brake cylinder comprises a substantially cylindrical body 1, a first end of which is partly closed by a wall 2 with the exception of an axial opening 3, whereas its second end is fully open and corresponds to the cross-sectional area which is constant from said second end of the body to about a mid point of its length and defines a cylindrical chamber in which a piston 4, having a matching outer shape, may slide.

In the opposite direction to its outer face bearing on a pad-supporting plate 5, the piston 4 comprises, on the one hand, a generally plane bottom wall 6 and, on the other hand, a peripheral skirt 7 defining both the outer cylindrical shape of the piston and an inner space in said piston, such space being open in the direction of the first end of the body.

A seal 8, accommodated inside an annular inner groove provided in the cylindrical chamber of the piston-housing body, takes charge of the tightness between the piston and said cylindrical chamber.

An axial bore 9 is made in the piston, from its bottom wall 6 towards the supporting plate. Such bore 9 provides the necessary room for the axial sliding motion of the end portion 10 of a first spacer-forming element 11, extending axially inside the body and engaged with a second spacer-forming element 12 so as to constitute an adjustable spacer abutting on a ramp-and-ball system, which comprises an input plate 13 and a moving plate 14 between which balls 15, received within ramped grooves, are disposed in a well-known manner.

The first spacer-forming element 11 is a nut extending in the axial direction, on the one hand, to the inside of the bore 9 and, on the other hand, towards the wall 2 of the body 1. Such nut engages the threaded shank 12a of a screw, unable to rotate but with a free translational motion, which constitutes the second spacer-forming element 12.

The input plate 13 comprises an extension, protruding through the opening 3 to the outside of the body, where a parking-brake control lever 16 is fitted to said extension and connected to a cable (not shown) leading to an actuating member (not shown), such as a hand lever or a pedal, mounted inside the passenger space of the vehicle.

The moving plate 14 is rotation-locked in relation to the body by means of a dowel 17.

The first spacer-forming element 11 comprises a flange 18, situated near the bottom wall 6 of the piston and forming a shoulder, limiting the axial travel of said first element towards the piston.

Such flange 18 comprises a truncated cone-shaped portion 18a towards the piston 4, whereas the piston 4 comprises a truncated cone-shaped seat 4a having a complementary shape. Thus, both truncated cone-shaped surfaces form a cone clutch which, when said truncated cone-shaped surfaces are bearing on each other, rotationally links the first spacer-forming element with the piston.

In other words, owing to the fact that the piston is secured against rotation by the supporting plate 5, when the flange 18 bears axially on the piston 4, the first spacer-forming element 11 cannot rotate any more.

The flange 18 is subjected to the action of a resilient washer 19, retained by a snap ring 20 within the peripheral skirt 7 of the piston. Since the washer 19 biases said flange 18 to lie flat on the truncated-cone shaped seat 4a of the piston, a ball bearing 21 is interposed between the flange 18 and the washer 19 in such a way that said resilient washer 19 will not keep the first element 11 from rotating about its longitudinal axis.

A cage or bell 22 encloses the ramp-and-ball system, namely the input plate 13, the balls 15 and the moving plate 14, as well as a portion of the second spacer-forming element 12, facing away from the piston.

A helical spring 23, intended to keep the second element 12 in position against the ramp-and-ball system, is also housed within the cage 22.

When no hydraulic forces are applied, the resilient washer 19 applies the flange 18 to the seat 4a, and the first element 11 is prevented from rotating through the cone clutch, whereas the helical spring 23 keeps the second element 12 against the ramp-and-ball system.

A cylindrical channel 24 is provided in the end portion 10 of the first element 11 and it opens in the direction of the piston, opposite the end wall 25 of the bore 9.

Such channel 24 consists of the longitudinal hole of the nut and, therefore, it extends over the full length of the latter and is in a hydraulic pressure equilibrium state with the interior of the cylinder.

A sliding shutter 26 is disposed at the mouth of the cylindrical channel 24 and takes charge of a tight sealing of the latter, so that the hydraulic fluid inside the cylinder may fill the channel but by no means escape from it.

The shutter exhibits a cup-generating form of revolution, which is favourable to the maintenance of a reliable tightness as regards the hydraulic fluid, even though such fluid may be under a high pressure because, owing to the action of such pressure, the periphery of said shutter is forcedly applied to the side wall of the channel.

But on the other hand, while opposing a hydraulic fluid leakage, the shutter 26 is capable of sliding in the mouth of the channel, by a travel which is determined by the axial distance between the end wall 25 of the bore 9 and the front wall of the first element 11.

Thus, should the hydraulic fluid be subjected to a high pressure, the shutter 26 would slide in the direction of the piston till it abuts against the end wall 25.

Therefore, the shutter imparts no axial force to the first spacer-forming element 11, in spite of the possible high pressure of the hydraulic fluid.

A further seal 27 is accommodated within an annular groove provided in the end portion 10 of the first element 11, engaging the bore 9. Such seal 27 is intended to isolate the terminal portion 11b of the first element from the interior of the cylinder, which means that the hydraulic fluid pressure prevailing inside the cylinder will not be applied to said terminal portion 11b of the first element 11.

It follows that the hydraulic fluid pressure, exerted on the first spacer-forming element, generates a resultant force, substantially equal to the product of the fluid pressure by the annular cross-sectional area of said first element, at right angles with the seal 27.

Said area is the so-called neutralization cross-section of the first element 11 and it corresponds to the area of the solid section of the screw head, minus the section of the channel 24.

Now, the mode of operation of the brake mechanism will be described.

Said mechanism may be actuated both hydraulically, which corresponds to a control using the brake pedal of the vehicle, and mechanically, which implies a control by the parking brake lever.

In the case of a hydraulic operation, the hydraulic fluid inside the body 1 of the cylinder is pressurized.

The first effect of such pressure is to push the piston 4 towards the outside of the body (to the left-hand side in the figure).

The piston stroke compresses the resilient washer 19 and consequently drives the first element 11 in the travel direction of the piston, thus moving said element away from the second element 12.

Accordingly, the spacer-forming elements tend to unscrew so as to lengthen the spacer.

However, the first element 11 is subjected, by the pressure fluid, to a resultant force (already described) which applies its flange 18 to the seat 4a of the piston, whereas the helical spring 23 exerts, on the second element 12, a force in the direction of the end wall 2 of the body.

Therefore, the first element 11 is subjected to two groups of counteracting forces, namely a force resulting from the action of the spring 23 and biasing it towards the wall 2 and, on the other hand, the sum of the forces resulting from the actions of both the pressure fluid and the resilient washer 19 and exerted in the direction of the piston 4.

When the fluid pressures are lower than a threshold pressure, defined as the pressure which actually compensates for the difference between the action of the spring 23 and that of the washer 19, the cone clutch disengages and therefore the first element 11 may freely rotate so as to unscrew and follow the piston. At that time, the brake is self-adjusting.

For fluid pressures which are higher than said threshold pressure, the action of the spring 23 is too weak to overcome the action exerted on the first element 11 by the fluid, and the clutch is sticking. It results in that the first element cannot rotate any longer, and the brake adjustment is inhibited.

In a mechanical mode of operation, the control lever 16 imparts a rotational motion to the input plate 13.

This plate starts rotating, whereas the dowel 17 secures the moving plate 14 against any rotational motion.

At that time, the ball ramps move the two plates apart from each other.

The flange 18 bears on the seat 4a and therefore precludes any rotational motion of the first element 11, with the result that the spacer is now capable of transmitting the translational motion from the ramp-and-ball system to the piston 4.

It is noteworthy that, according to this invention, in the course of a hydraulic braking operation, the force resulting from the action exerted by the fluid on the first element is actually restricted, which means that the helical spring may be less stiff and, accordingly, more compact.

Anyway, the invention is by no means limited to the above description and, more particularly, nothing prescribes that the stop-forming part for the first spacer-forming element has to be the piston, and a cone clutch might just as well be obtained using one of the plates of the ramp-and-ball system.

1. A mecanically and hydraulically actuated brake cylinder defining a tight chamber, capable of containing a pressure hydraulic fluid and housing a translationally-moving piston (4); a tappet-forming member (13, 14, 15) which can be moved towards the piston on a mechanical actuation of the brake; a spacer interposed between the piston and the tappet-forming member and consisting of two elements (11, 12), threaded the one into the other and capable of unscrewing so as to increase the length of the spacer, each element being in contact with a stop-forming part, i.e. the piston (4) and the tappet-forming member respectively, the first one (11) of the spacer-forming elements and the respective stop-forming part (4) with which it cooperates being shaped in such a way that they can come into gear for a rotational motion when said element is bearing on said stop-forming part; wherein the first spacer-forming element comprises an end portion (10) engaging a bore (9) provided in the stop-forming part (4), such bore being isolated from the chamber so that said end portion is not subjected to the fluid pressure inside the chamber, with the result that the pressure fluid exerts, on said first element, an axial force in the direction of the corresponding stop-forming part,
characterised in that a channel (24) is provided through the first element, so as to connect the cylinder chamber with the bore (9) in the stop-forming part, said channel being closed by a moving shutter (26) which, under the action of the pressure fluid within the chamber, bears on the end wall (25) of the bore while imparting substantially no axial force to said first spacer-forming element.

2. The brake cylinder according to claim 1, characterised in that the movable tappet-forming member is a ramp-and-ball mechanism comprising a swivelling input plate (13) and a moving plate (14), between which balls (15) are accommodated inside ramps provided in both plates.

3. The brake cylinder according to claim 1, characterised in that the first-spacer forming element (11) is a nut, the threaded hole of which constitutes the channel (24).

4. The brake cylinder according to any one of claim 1, characterised in that the stop-forming part (4) for the first element (11) is the piston.

5. The brake cylinder according to any one of claim 1, characterised in that the moving shutter (26) is a sliding inserted piece comprising a cylindrical body received inside the channel (24) which connects the cylinder chamber with the bore provided in the stop-forming part.
